(19) United States
(12) Patent Application Publication
(10) Pub. No.: US 2026/0045232 A1
(43) Pub. Date: Feb. 12, 2026

(54) DISPLAY DEVICE POWER CONSUMPTION

(71) Applicant: Ford Global Technologies, LLC, Dearborn, MI (US)

(72) Inventors: Biaohe Guo, Northville, MI (US); Mark Larry, Macomb, MI (US); Dongwoo Kim, South Lyon, MI (US)

(73) Assignee: Ford Global Technologies, LLC, Dearborn, MI (US)

(21) Appl. No.: 18/797,653

(22) Filed: Aug. 8, 2024

(51) Int. Cl. G09G 3/36

(52) U.S. Cl. CPC G09G 3/3607; G09G 2330/023

(57) ABSTRACT

While operating a display device at a predetermined voltage, a fitting function is determined based on respective greyscale images output by the display device. For respective color images output by the display device, respective actual power consumptions of the display device are determined. For the respective color images, respective power consumptions of the display device are predicted based on the fitting function. A best fit line is determined based on the respective actual power consumptions and the respective predicted power consumptions. While outputting an image via the display device, a total power consumption of the display device is predicted based on the best fit line and the fitting function.

### BACKGROUND

Systems that move and/or that have mobile components, including vehicles, robots, drones, cell phones etc., can be operated by acquiring and processing sensor data, including data regarding system status and data regarding an environment around the system. Computing devices included in a vehicle, for example, can format and output the data to display devices for vehicle occupants to view and interact with. A display device can display a wide variety of data including, but not limited to, vehicle control screens that control vehicle systems such a climate control and vehicle propulsion, vehicle status data such as vehicle speed, energy usage, and vehicle service notices, data regarding the environment around the vehicle such as traffic and navigation maps, entertainment data such as cable TV, movies, video games, and the Internet via web browsers, and cellular telephone data such as text messages.

### BRIEF DESCRIPTION OF THE DRAWINGS

FIG. 1 is a block diagram of a display simulation system.

FIG. 2 is a diagram of an example liquid crystal display (LCD).

FIG. 3 is a diagram of an example light emitting diode (LED) array.

FIG. 4 is a cross-sectional view of an example display device.

FIG. 5 is a flowchart diagram of an example process for determining a fitting function and a best fit line for a display device.

FIG. 6 is a flowchart diagram of an example process for predicting a total power consumption of the display device when outputting an image.

### DETAILED DESCRIPTION

Vehicle operation will be used herein as a non-limiting example of a system that can include a display. A vehicle can include one or more display devices. Vehicle data that can be displayed on display devices include vehicle operating data such as vehicle speed, vehicle energy quantity, (e.g., fuel or battery charge remaining), and alert messages regarding vehicle systems, (e.g., low tire pressure alert, engine temperature alert, etc.). Vehicle display devices can display the status of vehicle components such as climate control and lighting. Coupled with touch screen technology or voice recognition technology, a display device can display data regarding vehicle components and receive input from occupants regarding the control of vehicle components. Vehicle display devices can also be used to display image data from computing device memory or external sources such as the Internet. Examples of image data display include navigation data, videos, and web browsing.

A display device can include a liquid crystal display (LCD) and an addressable light emitting diode (LED) array arranged to backlight the LCD. Backlighting is a technique for applying illumination to an LCD from beneath the LCD. An addressable LED array includes one or more LEDs in addressable zones, meaning that the LEDs in each zone can be controlled separately. That is, LED zones can be controlled individually to supply light to corresponding LCD pixel areas so as to accommodate different image and illumination requirements. However, controlling the LED zones separately results in an output luminance and a total power consumption of the display device being non-linear, which reduces a likelihood of reliably predicting the total power consumption of the display device when displaying various images. Reliable prediction of the total power consumption of the display device when displaying various images assists in developing display devices so as to satisfy power consumption constraints when operating in a vehicle with limited power (e.g., due to a battery capacity) for operating various components of the vehicle.

As disclosed herein, a display device can be operated at a predetermined voltage to output various greyscale images and various color images. A fitting function can be determined based on the various greyscale images. A best fit line can be determined based on an actual power consumption for outputting the various color images and a predicted power consumption, as determined from the fitting function, for outputting the various color images. A total power consumption of the display device can be predicted for outputting an image based on the fitting function and the best fit line. Predicting the total power consumption based on the fitting function and the best fit line increases a likelihood of reliably, that is, with a degree of accuracy that can be relied upon, predicting the total power consumption by accounting for the non-linearity introduced by the addressable LED zones, which can, thereby, assist in developing the display device to satisfy power consumption constraints for a vehicle. Further, predicting the total power consumption can allow for development of displays with reduced thermal dissipation and reduce the need for active cooling systems within the displays, which can also reduce a power draw by the display from a vehicle battery.

A system includes a computer including a processor and a memory, the memory storing instructions executable by the processor to, while operating a display device at a predetermined voltage, determine a fitting function based on respective greyscale images output by the display device. The instructions further include instructions to determine, for respective color images output by the display device, respective actual power consumptions of the display device. The instructions further include instructions to predict, for the respective color images, respective power consumptions of the display device based on the fitting function. The instructions further include instructions to determine a best fit line based on the respective actual power consumptions and the respective predicted power consumptions. The instructions further include instructions to, while outputting an image via the display device, predict a total power consumption of the display device based on the best fit line and the fitting function.

The instructions can further include instructions to generate, for the respective color images, respective grayscale maps defining respective LCD pixel areas. The respective grayscale maps can represent pixels in the respective LCD pixel areas as respective grayscale values. The instructions can further include instructions to determine the respective grayscale values based on a maximum red, green, blue (RGB) pixel value of the pixels in the respective LCD pixel areas. The instructions can further include instructions to determine respective grayscale variations for the respective color images based on combining respective differences between the respective grayscale values of the respective LCD pixel areas that are adjacent to each other within the respective grayscale maps. The instructions can further include instructions to determine the best fit line based additionally on the respective grayscale variations. The instructions can further include instructions to predict the respective power consumptions of the display device based additionally on the respective grayscale values and a number of the respective LCD pixel areas.

The instructions can further include instructions to operate the display device at the predetermined voltage to output the image.

The instructions can further include instructions to operate the display device at the predetermined voltage to output the respective color images. The instructions can further include instructions to, for the respective color images output by the display device, determine respective currents input to the display device. The respective actual power consumptions of the display device can be determined based on the respective currents and the predetermined voltage.

A method includes, while operating a display device at a predetermined voltage, determining a fitting function based on respective greyscale images output by the display device. The method further includes determining, for respective color images output by the display device, respective actual power consumptions of the display device. The method further includes predicting, for the respective color images, respective power consumptions of the display device based on the fitting function. The method further includes determining a best fit line based on the respective actual power consumptions and the respective predicted power consumptions. The method further includes, while outputting an image via the display device, predicting a total power consumption of the display device based on the best fit line and the fitting function.

The method can further include generating, for the respective color images, respective grayscale maps defining respective LCD pixel areas. The respective grayscale maps can represent pixels in the respective zones as respective grayscale values. The method can further include determining the respective grayscale values based on a maximum red, green, blue (RGB) pixel value of the pixels in the respective LCD pixel areas. The method can further include determining respective grayscale variations for the respective color images based on combining respective differences between the respective grayscale values of the respective LCD pixel areas that are adjacent to each other within the respective grayscale maps. The method can further include determining the best fit line based additionally on the respective grayscale variations. The method can further include predicting the respective power consumptions of the display device based additionally on the respective grayscale values and a number of the respective LCD pixel areas.

The method can further include operating the display device at the predetermined voltage to output the image.

The method can further include operating the display device at the predetermined voltage to output the respective color images. The method can further include, for the respective color images output by the display device, determining respective currents input to the display device. The respective actual power consumptions of the display device can be determined based on the respective currents and the predetermined voltage.

Further disclosed herein is a computing device programmed to execute any of the above method steps. Yet further disclosed herein is a computer program product, including a computer readable medium storing instructions executable by a computer processor, to execute an of the above method steps.

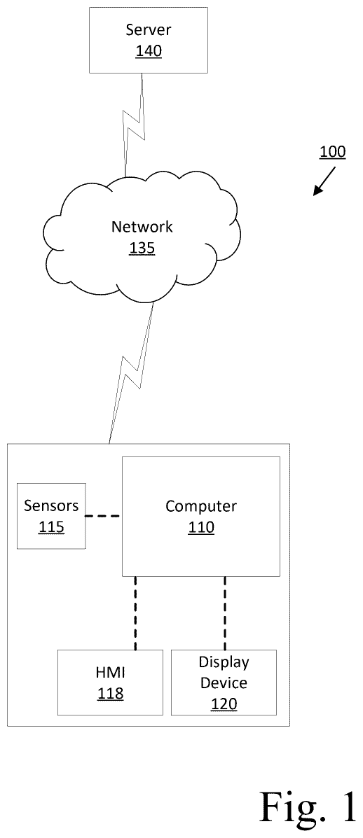

With reference to FIG. 1, an example simulation system 100 includes a computer 110. The simulation system 100 can simulate operating conditions of a display device. For example, the display device may be included in various objects (e.g., in a vehicle, in a computer monitor, in a handheld device, etc.) to display various data at various brightness levels based on lighting (e.g., natural or artificial lighting, static or dynamic brightness levels, etc.) of an environment around the display device. The computer 110 is programmed to, while operating a display device at a predetermined voltage, determine a fitting function based on respective greyscale images output by the display device. The computer 110 is further programmed to determine, for respective color images output by the display device, respective actual power consumptions of the display device. The computer 110 is further programmed to predict, for the respective color images, respective power consumptions of the display device based on the fitting function. The computer 110 is further programmed to determine a best fit line based on the respective actual power consumptions and the respective predicted power consumptions. The computer 110 is further programmed to, while outputting an image via the display device, predict a total power consumption of the display device based on the best fit line and the fitting function.

The simulation system 100 may include hardware and software such as is known (and/or that could be developed or built in the future). The simulation system 100 may include the computer 110, sensors 115, a display controller 117, and a display device 120. As discussed further below, the simulation system 100 can simulate operation of the display device 120.

The computer 110 includes a processor and a memory. Further, the memory includes one or more forms of computer-readable media, and stores instructions executable by the processor for performing various operations, including as disclosed herein. The computer 110 is generally arranged for communications on a communication network that can include a controller area network (CAN) or the like, and/or other wired and/or wireless mechanisms. Via the communication network, the computer 110 may receive messages (e.g., CAN messages) from the various devices (e.g., sensors 115, the display controller 117, etc.) in the simulation system 100. For example, the sensors 115 may provide the computer 110 with data about the display device 120 being used for simulation. As another example, the display controller 117 may receive visual data to be displayed on the display device 120 in a visual format from the computer 110. As mentioned below, various controllers and/or sensors 115 may provide data to the computer 110 via the communication network. Additionally, the computer 110 may transmit messages to a remote server computer 140 (e.g., via a network 135 as discussed below).

The computer 110 can collect and process data about the display device 120 being used for simulation. Based on the data, the computer 110 can actuate the display device 120 during the simulation. For example, the computer 110 can control actuation of the display device 120 being simulated (e.g., to display various images). The computer 110 may be an electronic control unit (ECU). An “electronic control unit” (ECU) is a device including a processor and a memory that includes programming (i.e., the memory stores instructions executable by the processor) to control a vehicle component or subsystem such as a subsystem including one or more display devices 120.

Sensors 115 can include a variety of devices. For example, sensors 115 could include cameras, light sensors (e.g., photodiodes, photoresistors, phototransistors, photovoltaic light sensors, etc.), luminescence sensors, etc., to provide data (e.g., data relating to current, luminance, etc.) via wired communication to the computer 110.

The display controller 117 may be a computing device programmed to monitor and control the display device 120. A controller may be an ECU, possibly including additional programming as described herein. The display controller 117 may be communicatively connected to and receive instructions from the computer 110 (e.g., via the communication network) to actuate the display device 120 according to the instructions. For example, the display controller 117 may receive instructions from the computer 110 to display various images on the display device 120. Alternatively, the display controller 117 may be included in the computer 110.

The simulation system 100 further includes a human-machine interface (HMI) 118. The HMI 118 includes user input devices such as knobs, buttons, switches, pedals, levers, touchscreens, and/or microphones, etc. The input devices may include sensors 115 to detect a user input and provide user input data to the computer 110. That is, the computer 110 may be programmed to receive user input from the HMI 118. A user may provide the user input via the HMI 118 (e.g., by selecting a virtual button on a touchscreen display, by providing voice commands, etc.). For example, a touchscreen display included in an HMI 118 may include sensors 115 to detect that a user selected a virtual button on the touchscreen display to, for example, select or deselect various images for display via the display device 120, which input can be received in the computer 110 and used to determine the selection of the user input.

The HMI 118 typically further includes output devices such as displays (including touchscreen displays), speakers, and/or lights, etc., that output signals or data to the occupant. For example, the HMI 118 may include the display device 120. As another example, the HMI 118 may include an output display that is distinct from the display device 120. That is, the display device 120 may be separate from the HMI 118. The HMI 118 may be coupled via wired communication to the computer 110 and can send and/or receive messages to/from the computer 110 and other vehicle sub-systems.

The display device 120 displays two-dimensional visual data to occupants of a vehicle. The display device 120 can display visual data in monochrome or color and the visual data can be updated at a frame rate, which can be 60 frames per second, for example. Displayed visual data can be a static image, where the majority of the two dimensional area does not change from frame to frame, or a dynamic image, where the majority of the two dimensional area changes from frame to frame. For static images, changes to luminance of LED zones occur at frame rates less than a threshold and generally do not change more than a small percentage of the display area. For example, a static image might be data included in a climate control panel display, where the changes only occur in response to occupant input or changes in vehicle interior temperature. For dynamic images, changes to luminance of LED zones can occur at frame rates greater than the threshold and change large percentages of the display area. Examples of a dynamic image include video content and web browsers. The threshold may be specified as a video frame rate (i.e., 60 frames per second).

The network 135 represents one or more mechanisms by which the computer 110 may communicate with remote computing devices (e.g., the remote server computer 140, a mobile device, etc.). Accordingly, the network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

The remote server computer 140 can be a conventional computing device (i.e., including one or more processors and one or more memories) programmed to provide operations such as disclosed herein. Further, the remote server computer 140 can be accessed via the network 135 (e.g., the Internet, a cellular network, and/or some other wide area network).

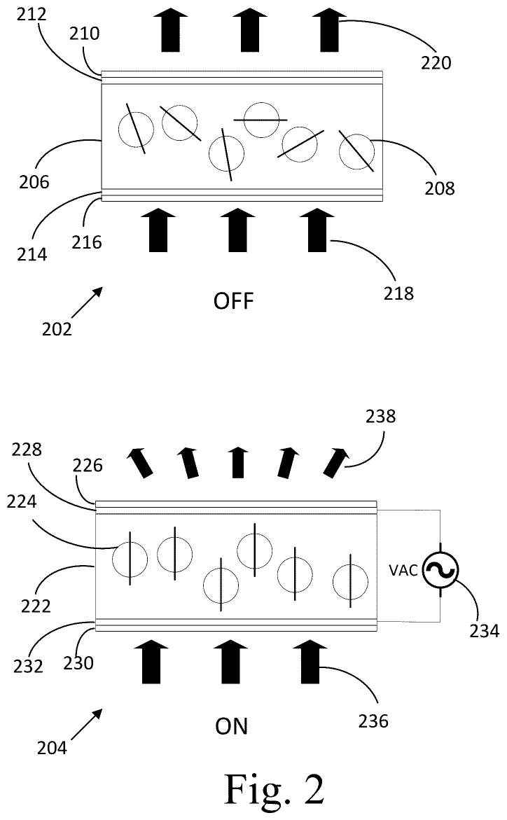

FIG. 2 is a diagram of two cross sectional views of portions of liquid crystal displays (LCDs) 202, 204. LCD 202 is a cross sectional view of a twisted nematic liquid crystal display in an ON state and LCD 204 is a cross sectional view of a twisted nematic liquid crystal display in an OFF state. An LCD 202, 204 includes two paired polarizer layers 210, 216 and 226, 230. The paired polarizer layers 210, 216 are arranged to be at 90 degree polarization angles (normally off) or 0 degrees (normally on) depending upon the desired appearance of the display device 120. The interior space 206, 222 of the LCDs can be filled with liquid crystal molecules 208, 224, which can be a material that rotationally polarizes light such as a twisted nematic liquid crystal molecule. LCDs 202, 204 do not emit light directly, but transmit varying degrees of input light 218, 236, depending upon voltage 234 applied across paired electrodes 212, 214 and 228, 232, generating output light 220, 238. The electrodes can be applied to a glass substrate and can be made of a transparent, conductive material such as indium-tin oxide (ITO).

Assuming a normally ON (i.e., providing 90 degree polarization when input light is applied) LCD 202, then in the OFF state, the liquid crystal molecules 208 assume a helical pattern between the electrodes 212, 214. The helical pattern imparts a 90 degree polarization in light 218 being transmitted by LCD 202. The 90 degree polarization imparted to the light causes the input polarizer 216 to match the output polarizer 210, which permits a large percentage of the input light 218 to appear as output light 220. Applying a voltage 234 across the electrodes 228, 232 causes the liquid crystal molecules 224 to line up with one end towards one electrode 228 and the other end towards the other electrode 232, which prevents the liquid crystal molecules from imparting a polarization to the input light 236 which then permits the crossed polarizer layers 226, 230 to block light, making the LCD 204 non-transmissive and reducing the light output 238 from the LCD 204. Varying voltage 234 can change the light output 220, 238 from bright (no voltage) to dark (maximum voltage).

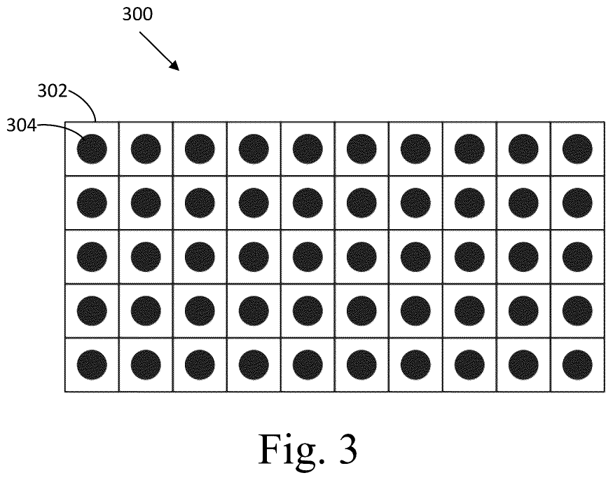

In addition to varying voltage 234 to determine light output 238, light output 220, 238 can depend upon the light input 218, 236. Backlighting is a technique for applying illumination to an LCD 202, 204 from beneath the lower polarizer 216, 230. Techniques for backlighting employing an addressable LED array to backlight an LCD 202, 204. As illustrated in FIG. 3, an addressable LED array includes one or more LEDs in addressable zones, meaning that the LEDs in each zone can be controlled separately. Each LED zone can include multiple LEDs, which can be controlled separately to yield white light at any intensity from off (black) to the maximum intensity of the LEDs. This permits the LED backlight to illuminate different portions of the LCD 202, 204 having different types of backlight requirements.

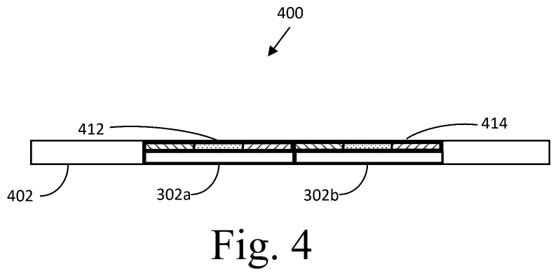

FIG. 3 is a diagram of an example LED backlight 300. The LED backlight 300 includes an array of LEDs 304 arranged in LED zones 302. Each LED zone 302 can include one or more LEDs 304 . . . . LEDs 304 in LED zones 302 can be controlled separately to generate backlighting patterns to illuminate different portions of the LCD 202, 204. As described below in relation to FIG. 4, LEDs 304 in LED zones 302 can be energized to different levels of luminance while adjacent LCD pixel areas 412, 414 are energized to different levels transparency and non-transparency to display various visual data via the display device 120.

FIG. 4 is a diagram of an example cross-sectional view of the display device 120. The display device 120 includes display substrate 402 that includes LED zones 302a, 302b and matching LCD pixel areas 412, 414, respectively, disposed in a plane formed by display substrate 402. LCD pixel areas 412, 414 can include various numbers of pixels, which can each include red, green, and blue subpixels, illustrated by three different types of cross-hatching. LEDs included in LED zones 302a, 302b emit different levels of luminance, (e.g. light), in response to being energized by differing voltages applied to the LEDs in LED zones 302a, 302b by display controller 117 to provide backlighting for LCD pixel areas 412, 414. LCD pixel areas 412, 414 are constructed as illustrated in FIG. 2 and are wired to be individually controllable by a display controller 117, (e.g., to transmit or block light emitted by LED zones 302a, 302b to generate various colors) to emit display data. LCD pixel areas 412, 414 transmit varying amounts of luminance emitted by LED zones 302a, 302b, in response to being energized by voltages applied to the LCD pixel areas412, 414 by display controller 117 to switch the LCD pixel areas 412, 414 between transparency and non-transparency. Further, the LCD pixel areas 412, 414 can include color filters that can output different colors based on the amount of luminance emitted by the LED zones 302a, 302b and the levels of transparency of the LCD pixel areas 412, 414.

The computer 110 is programmed to determine a fitting function based on greyscale images. The fitting function represents a relationship between a current input to the display device 120 and a greyscale image output by the display device 120. A greyscale image is an image in which each pixel has a same pixel value within a greyscale range (e.g., 0 to 255, inclusive). Various greyscale images can be maintained in a database, or the like. The computer 110 can access the database (e.g., stored in a memory of the computer 110) to iteratively or sequentially select greyscale images until each greyscale image has been output by the display device 120. As another example, the computer 110 can select greyscale images in response to receiving respective user inputs (e.g., via the HMI 118) specifying the respective greyscale images.

The computer 110 operates the display device 120 at a predetermined voltage to output the greyscale images. The predetermined voltage can, for example, be determined empirically (e.g., based on testing and/or simulation to determine a voltage that permits the display device 120 to output light at a luminance that satisfies design parameters). As another example, the computer 110 can determine the predetermined voltage in response to receiving (e.g., via the HMI 118) a user input specifying the predetermined voltage. The predetermined voltage may be stored (e.g., in a memory of the computer 110).

To display a greyscale image, the computer 110 energizes the display device 120 (i.e., the LED zones 302 and the LCD pixel areas 412, 414) at the predetermined voltage to generate the pixel value specified by the greyscale image. The computer 110 can then determine the current input to the display device 120 that results in output of the greyscale image at the predetermined voltage. For example, the computer 110 can receive sensor 115 data indicating the current input to the display device 120. The computer 110 can determine the current input to the display device 120 that results in output of the various greyscale images in this manner.

The computer 110 can then generate a plot that graphically represents the currents input to the display device 120 and the corresponding greyscale images output by the display device 120. The computer 110 can perform curve fitting operations to determine the fitting function. The fitting function is stored (e.g., in a memory of the computer 110). Curve fitting operations are programming that generates a function to represent the relationship between the currents input to the display device 120 and the greyscale images output by the display device 120. Examples of curve fitting operations are included in the MatLab® software library produced by MathWorks®, Natick, MA 01760. The curve fitting operations may be stored (e.g., in a memory of the computer 110).

The fitting function predicts a current input to the display device 120 when outputting a greyscale image:

$${I}_{c} = {a}_{0} + {a}_{1} x + {a}_{2} {x}^{2} + {a}_{3} {x}^{3} + … + {a}_{n} {x}^{n} \qquad ( 1 )$$

where x is the pixel value, the coefficients α₁ through αₙ represent polynomial coefficients describing the fitting function, and α₀ is an offset, (i.e., a total current input to operate the display device 120 to display a black image).

Additionally, the computer 110 is programmed to determine a best fit line based on an actual power consumption by the display device 120 when outputting colors images and a predicted power consumption by the display device 120 when outputting the color images. A color image is an image in which each pixel has a vector of three values that represent components (e.g., red, green, and blue) of the pixel. Various color images can be maintained in a second database, or the like. The computer 110 can access the second database (e.g., stored in a memory of the computer 110) to iteratively or sequentially select color images until each color image has been output by the display device 120. As another example, the computer 110 can select color images in response to receiving respective user inputs (e.g., via the HMI 118) specifying the respective color images. The color images can be manually generated to represent various visual data to be presented to a vehicle user.

The computer 110 operates the display device 120 at the predetermined voltage to output the color images. To display a color image, the computer 110 energizes the display device 120 at the predetermined voltage to generate respective colors corresponding to the respective LCD pixel areas 412, 414. The computer 110 can determine the current input to the display device 120 that results in output of the color image at the predetermined voltage (e.g., via sensor 115 data as discussed above). The computer 110 can then determines the actual power consumption of the display device 120 when outputting the color image according to:

$${P}_{a} = V * {I}_{a} \qquad ( 2 )$$

where P_{α} is the actual power consumption by the display device 120 to output the color image, V is the predetermined voltage, and Ia is the current input to the display device 120 to output the color image.

To predict the power consumption of the display device 120 when outputting the color image, the computer 110 can determine, for each LCD pixel area 412, 414, a maximum RGB value (e.g., by comparing the RGB values of the respective subpixels within the respective LCD pixel areas 412, 414 to each other) and can set the RGB values for each subpixel within the respective LCD pixel areas 412, 414 to the maximum RGB value of the respective subpixel within the respective LCD pixel area 412, 414. Setting the RGB values for each subpixel within the respective LCD pixel area 412, 414 to the maximum RGB value generates a greyscale map that represents the various LCD pixel areas 412, 414 as corresponding greyscale values.

For each LCD pixel area 412, 414, the computer 110 can input the greyscale value to the fitting function that outputs a predicted current input to the LCD pixel area 412, 414. The computer 110 predicts the power consumption of an LCD pixel area 412, 414 when outputting the color image according to:

$${P}_{Z} = V / N * {I}_{p} \qquad ( 3 )$$

where P_{z} is the predicted power consumption of the LCD pixel area 412, 414 when outputting the color image, and Iₚ is the current output from the fitting function.

The computer 110 can then predict the power consumption of the display device 120 when outputting the color image by summing the predicted power consumptions P_{z} of each LCD pixel area 412, 414:

$${P}_{p} = {\sum }_{i = 1}^{j} {P}_{z} ( i ) \qquad ( 4 )$$

The computer 110 can determine a power offset Pₒ of the display device 120 when outputting the color image based on the actual power consumption P_{α} and the predicted power consumption Pₚ:

$${P}_{o} = \frac{{P}_{p}}{{P}_{a}} \qquad ( 5 )$$

The computer 110 can determine a power offset Pₒ for outputting each color image in the manner described above.

Additionally, the computer 110 can determine a greyscale variation for the greyscale map. The greyscale variation is a sum of differences between greyscale values of adjacent LCD pixel areas 412, 414. The computer 110 can determine the greyscale variation according to:

$${G}_{v} = {\sum }_{i = 1}^{n} ( \vert {G}_{1} - {G}_{a} ( i ) \vert ) + {\sum }_{i = 1}^{n} ( \vert {G}_{2} - {G}_{a} ( i ) \vert ) + … + {\sum }_{i = 1}^{n} ( \vert {G}_{N} - {G}_{a} ( i ) \vert ) \qquad ( 6 )$$

where Gᵥ is the greyscale variation, G_{1 . . . N} is a greyscale value for an LCD pixel area 412, 414, N is the number of LCD pixel areas 412, 414 in the greyscale map, G_{α} is a greyscale value for an adjacent LCD pixel area 412, 414, and n is the number of adjacent LCD pixel areas 412, 414. The computer 110 can determine a greyscale for outputting each color image in the manner just described.

As one non-limiting example, the computer 110 can determine that LCD pixel areas 412, 414 are adjacent to each other based on the LCD pixel areas 412, 414 being contiguous (i.e., sharing at least a portion of a border) in a horizontal direction relative to the display device 120. As another non-limiting example, the computer 110 can determine that LCD pixel areas 412, 414 are adjacent to each other based on the LCD pixel areas 412, 414 being contiguous in a vertical direction relative to the display device 120. As another non-limiting example, the computer 110 can determine that LCD pixel areas 412, 414 are adjacent to each other based on the LCD pixel areas 412, 414 being contiguous in both the vertical and horizontal directions. As yet another non-limiting example, the computer 110 can determine that LCD pixel areas 412, 414 are adjacent to each other based on the LCD pixel areas 412, 414 being contiguous in the vertical and horizontal directions as well as at least one oblique direction (i.e., neither parallel nor perpendicular to either the vertical or horizontal directions). As yet another non-limiting example, the computer 110 can determine the adjacent LCD pixel areas 412, 414 in response to receiving (e.g., via the HMI 118) a user input specifying the adjacent pixels.

The computer 110 can scale the greyscale variation (e.g., by a factor of 10, 100, etc.). A scaling factor may be proportional to the number of adjacent LCD pixel areas 412, 414. As one example, the computer 110 can determine the scaling factor in response to receiving (e.g., via the HMI 118) a user input specifying the scaling factor. As another example, the computer 110 can determine the scaling factor based on the greyscale variation being greater than or equal to a threshold (e.g., stored in a memory of the computer 110). The threshold may be determined empirically (e.g., based on testing and/or simulation to determine a range of greyscale variations that permit determination of the best fit line within a specified time (e.g., based on available computational resources). The scaling factor may be stored (e.g., in a memory of the computer 110).

The computer 110 can then generate a plot that graphically represents the greyscale variations and the corresponding power offsets associated with the various color images. The computer 110 determines the best fit line for the greyscale variations and the power offsets (e.g., according to current calculation methods (e.g., linear least squares, linear regression, random sample consensus (RANSAC), etc.)). The best fit line is a line through points (representing the power offset corresponding to the greyscale variation) that minimizes respective distances between the respective points and the line. The best fit line may be stored (e.g., in a memory of the computer 110).

Upon determining the fitting function and the best fit line, the computer 110 is programmed to predict a total power consumption by the display device 120 when the display device 120 outputs an image. The computer 110 may, for example, receive the image from the remote server computer 140 (e.g., via the network 135). As another example, the image may be stored by a remote device (e.g., in a memory thereof). The remote device may be connected to the computer 110 via a wired connection. In this situation, the computer 110 may access the memory of the remote device (e.g., via the wired connection) to obtain the image.

The computer 110 operates the display device 120 to display the image. Specifically, the computer 110 energizes the LCD pixel areas 412, 414 at the predetermined voltage to display the image. The computer 110 can generate a greyscale map of the image and determine a greyscale variation of the image in the same manner as described above. The computer 110 can then determine a power offset Por for outputting the image based on the best fit line and the greyscale variation of the image. For example, the computer 110 can input the greyscale variation of the image into a function defining the best fit line that outputs the power offset Por for outputting the image.

Additionally, the computer 110 can determine, for each LCD pixel area 412, 414, greyscale values, as discussed above. The computer 110 can predict a power consumption Pₚ of the display device 120 when outputting the image based on inputting the greyscale values to the fitting function and Equations 3 and 4, as discussed above. The computer 110 then predicts a total power consumption P_{T} of the display device 120 when outputting the image according to:

$${P}_{T} = \frac{{P}_{p}}{{P}_{oI}} \qquad ( 7 )$$

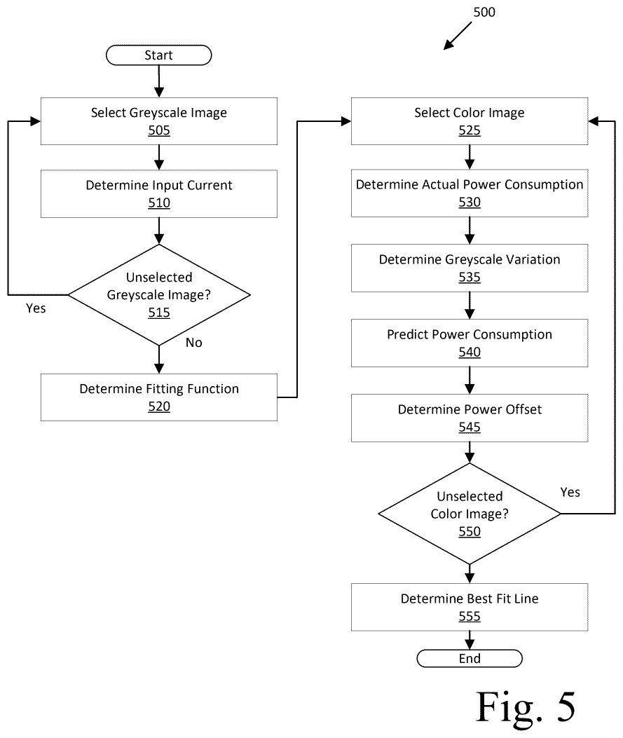

FIG. 5 is a flowchart diagram of a process 500 for determining a fitting function and a best fit line for a display device 120. Process 500 can be implemented as software executing on a computer 110 and hardware including the display device 120 as described herein. Process 500 includes multiple blocks that can be executed in the illustrated order. Process 500 could alternatively or additionally include fewer blocks and can include the blocks executed in different orders. The process 500 begins in block 505.

In the block 505, the computer 110 selects a greyscale image. For example, the computer 110 can iteratively select greyscale images from a database, as discussed above. As another example, the computer 110 can select greyscale images based on user inputs specifying the greyscale images, as discussed above. The process 500 continues in a block 510.

In the block 510, the computer 110 determines a current input to the display device 120. For example, the computer 110 can actuate the display device 120 at a predetermined voltage to output the selected greyscale image, as discussed above. The computer 110 can then, for example, determine the current input to the display device 120 to output the selected greyscale image based on sensor 115 data, as discussed above. The process 500 continues in a block 515.

In the block 515, the computer 110 determines whether at least one greyscale image remains unselected. For example, the computer 110 can access the database to determine whether each greyscale image has been selected. If the computer 110 determines that at least one greyscale image is indicated as being unselected in the database, then the process 500 returns to the block 505. If the computer 110 determines that all greyscale images are indicated as being selected in the database, then the process 500 continues in the block 520.

In the block 520, the computer 110 determines a fitting function based on the greyscale images and the input currents. As discussed above, the fitting function represents a relationship between a current input to the display device 120 and a greyscale image output by the display device 120. The computer 110 can, for example, generate a plot representing the pixel values of the greyscale images and the corresponding currents into the display device 120. The computer 110 can determine the fitting function based on curve fitting operations, as discussed above. The fitting function is stored (e.g., in a memory of the computer 110). The process 500 continues in a block 525.

In the block 525, the computer 110 selects a color image. For example, the computer 110 can iteratively select color images from a second database, as discussed above. As another example, the computer 110 can select color images based on second user inputs specifying the color images, as discussed above. The process 500 continues in a block 530.

In the block 530, the computer 110 determines an actual power consumption of the display device 120 when outputting the selected color image. For example, the computer 110 can actuate the display device 120 at a predetermined voltage to output the selected color image, as discussed above. The computer 110 can then, for example, determine the current input to the display device 120 to output the selected color image based on sensor 115 data, as discussed above. The computer 110 can determine the actual power consumption of the display device 120 according to Equation 2, as discussed above. The process 500 continues in a block 535.

In the block 535, the computer 110 determines a greyscale variation of the selected color image. For example, the computer 110 can then set a pixel value for each subpixel in the respective LCD pixel area 412, 414 to a maximum RGB value of the subpixels in the respective LCD pixel area 412, 414, as discussed above. The computer 110 can then determine the greyscale variation based on summing differences between pixel values of adjacent LCD pixel areas 412, 414 (e.g., according to Equation 3), as discussed above. The computer 110 may scale the greyscale variation (e.g., based on a number of adjacent LCD pixel areas 412, 414 (e.g., specified by a user input)), as discussed above. The process 500 continues in a block 540.

In the block 540, the computer 110 predicts a power consumption of the display device 120 when outputting the selected color image based on the fitting function. For example, the computer 110 can, for each LCD pixel area 412, 414, input the maximum RGB value of the respective LCD pixel area 412, 414 into the fitting function that outputs a predicted current, as discussed above. The computer 110 can then predict a power consumption of the LCD pixel area 412, 414 according to Equation 3. To predict the power consumption of the display device 120 when outputting the selected color image, the computer 110 can sum the predicted power consumptions of the LCD pixel areas 412, 414, as discussed above. The process continues in a block 545.

In the block 545, the computer 110 determines a power offset Pₒ according to Equation 5. The process 500 continues in a block 550.

In the block 550, the computer 110 determines whether at least one color image warrants selection. For example, the computer 110 can access the second database to determine whether each color image has been selected. If the computer 110 determines that at least one color image is indicated as warranting selection in the second database, then the process 500 returns to the block 525. If the computer 110 determines that all color images are indicated as being selected in the second database, then the process 500 continues in the block 555.

In the block 555, the computer 110 determines a best fit line based on the greyscale variations and the corresponding power offsets associated with the various color images. The computer 110 can, for example, generate a plot representing the greyscale variations and the corresponding power offsets associated with the various color images. The computer 110 can determine the best fit line according to current calculation methods, as discussed above. The computer 110 can store the best fit line (e.g., in a memory thereof). The process 500 ends following the block 555.

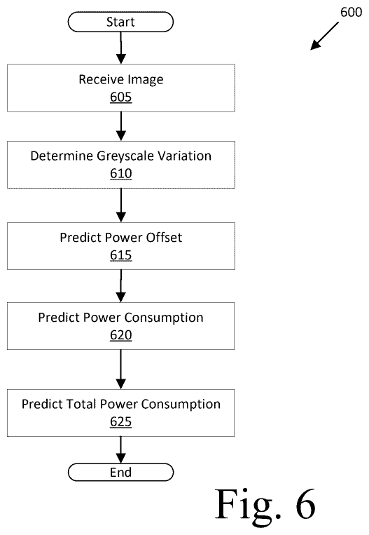

FIG. 6 is a flowchart diagram of a process 600 for predicting a total power consumption by a display device 120 when the display device 120 outputs an image. Process 600 can be implemented as software executing on the computer 110 and hardware including the display device 120 as described herein. Process 600 includes multiple blocks that can be executed in the illustrated order. Process 600 could alternatively or additionally include fewer blocks and can include the blocks executed in different orders. The process 600 begins in block 605.

In the block 605, the computer 110 receives an image. For example, the computer 110 can receive the image from a remote computer, as discussed above. That is, the image is absent from the database and the second database. The process 600 continues in a block 610.

In the block 610, the computer 110 determines a greyscale variation of the image. The block 610 is substantially identical to the block 535 in the process 500 and therefore will not be described further to prevent redundancy. The process 600 continues in a block 615.

In the block 615, the computer 110 determines a power offset Por based on the best fit line. For example, the computer 110 can input the greyscale variation of the image into a function defining the best fit line that outputs the power offset Por for outputting the image, as discussed above. The process 600 continues in a block 620.

In the block 620, the computer 110 predicts a power consumption of the display device 120 when outputting the image. The block 620 is substantially identical to the block 540 in the process 500 and therefore will not be described further to prevent redundancy. The process 600 continues in a block 625.

In the block 625, the computer 110 then predicts a total power consumption P_{T} of the display device 120 when outputting the image according to Equation 7. The process 600 ends following the block 625.

Computing devices such as those described herein generally each includes commands executable by one or more computing devices such as those identified above, and for carrying out blocks or steps of processes described above. For example, process blocks described above may be embodied as computer-executable commands.

Computer-executable commands may be compiled or interpreted from computer programs created using a variety of programming languages and technologies, including, without limitation, and either alone or in combination, Java™, C, C++, Python, Julia, SCALA, Visual Basic, Java Script, Perl, HTML, etc. In general, a processor (i.e., a microprocessor) receives commands, (i.e., from a memory, a computer-readable medium, etc.), and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random access memory, etc.

A computer-readable medium (also referred to as a processor-readable medium) includes any non-transitory (i.e., tangible) medium that participates in providing data (i.e., instructions) that may be read by a computer (i.e., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, (i.e., a candidate to an “exemplary widget” should be read as simply referring to an example of a widget).

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same reference numbers indicate the same elements. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

1. A system, comprising a computer including a processor and a memory, the memory storing instructions executable by the processor to:
while operating a display device at a predetermined voltage, determine a fitting function based on respective greyscale images output by the display device;
determine, for respective color images output by the display device, respective actual power consumptions of the display device;
predict, for the respective color images, respective power consumptions of the display device based on the fitting function; wherein the fitting function represents a relationship between a current input to the display device and a greyscale image output by the display device;
determine a best fit line based on the respective actual power consumptions and the respective predicted power consumptions; and
while outputting an image via the display device, predict a total power consumption of the display device based on the best fit line determined based on the respective actual power consumptions and the respective predicted power consumptions of the display device for the respective color images and the fitting function that represents a relationship between a current input to the display device and a greyscale image output by the display device.

2. The system of claim 1, wherein the instructions further include instructions to generate, for the respective color images, respective grayscale maps defining respective LCD pixel areas, the respective grayscale maps representing pixels in the respective LCD pixel areas as respective grayscale values.

3. The system of claim 2, wherein the instructions further include instructions to determine the respective grayscale values based on a maximum red, green, blue (RGB) pixel value of the pixels in the respective LCD pixel areas.

4. The system of claim 2, wherein the instructions further include instructions to determine respective grayscale variations for the respective color images based on combining respective differences between the respective grayscale values of the respective LCD pixel areas that are adjacent to each other within the respective grayscale maps.

5. The system of claim 4, wherein the instructions further include instructions to determine the best fit line based additionally on the respective grayscale variations.

6. The system of claim 2, wherein the instructions further include instructions to predict the respective power consumptions of the display device based additionally on the respective grayscale values and a number of the respective LCD pixel areas.

7. The system of claim 1, wherein the instructions further include instructions to operate the display device at the predetermined voltage to output the image.

8. The system of claim 1, wherein the instructions further include instructions to operate the display device at the predetermined voltage to output the respective color images.

9. The system of claim 8, wherein the instructions further include instructions to, for the respective color images output by the display device, determine respective currents input to the display device.

10. The system of claim 9, wherein the respective actual power consumptions of the display device are determined based on the respective currents and the predetermined voltage.

11. A method, comprising:
while operating a display device at a predetermined voltage, determining a fitting function based on respective greyscale images output by the display device;
determining, for respective color images output by the display device, respective actual power consumptions of the display device;
predicting, for the respective color images, respective power consumptions of the display device based on the fitting function; wherein the fitting function represents a relationship between a current input to the display device and a greyscale image output by the display device;
determining a best fit line based on the respective actual power consumptions and the respective predicted power consumptions; and
while outputting an image via the display device, predicting a total power consumption of the display device based on the best fit line determined based on the respective actual power consumptions and the respective predicted power consumptions of the display device for the respective color images and the fitting function that represents a relationship between a current input to the display device and a greyscale image output by the display device.

12. The method of claim 11, further comprising generating, for the respective color images, respective grayscale maps defining respective LCD pixel areas, the respective grayscale maps representing pixels in the respective zones as respective grayscale values.

13. The method of claim 12, further comprising determining the respective grayscale values based on a maximum red, green, blue (RGB) pixel value of the pixels in the respective LCD pixel areas.

14. The method of claim 12, further comprising determining respective grayscale variations for the respective color images based on combining respective differences between the respective grayscale values of the respective LCD pixel areas that are adjacent to each other within the respective grayscale maps.

15. The method of claim 14, further comprising determining the best fit line based additionally on the respective grayscale variations.

16. The method of claim 12, further comprising predicting the respective power consumptions of the display device based additionally on the respective grayscale values and a number of the respective LCD pixel areas.

17. The method of claim 11, further comprising operating the display device at the predetermined voltage to output the image.

18. The method of claim 11, further comprising operating the display device at the predetermined voltage to output the respective color images.

19. The method of claim 18, further comprising, for the respective color images output by the display device, determining respective currents input to the display device.

20. The method of claim 19, wherein the respective actual power consumptions of the display device are determined based on the respective currents and the predetermined voltage.
